(19) United States
(12) Patent Application Publication
(10) Pub. No.: US 2002/0146119 A1
(43) Pub. Date: Oct. 10, 2002

(54) Two channel secure communication

(76) Inventor: Alexander Liss, New York, NY (US)

Correspondence Address: Alexander Liss, 333 E 66 St Apt 5C, New York, NY, 10021, US

(21) Appl. No.: 09/775,942

(22) Filed: Feb. 5, 2001

(51) Int. Cl. H04L 9/00

(52) U.S. Cl. 380/42

(57) ABSTRACT

The invention is a method of encrypted communication, where instead of one communication channel between two communicating parties there are two channels; one channel is used to pass an one-time pad encrypted with the use of a private key, known to both parties, and the other channel is used to pass messages, encrypted with the help of this one-time pad; the one-time pad and messages are created and exchanged concurrently.

### BACKGROUND OF THE INVENTION

The invention relies on well known methods of protection of communication with the use of cryptography (see for example, A. Menezes, P. Oorschot, Scott Vanstone Handbook of Applied Cryptography, CRC Press, 1997).

Among strong methods of encryption is a method based on one-time pad. In this method, there is a sequence or a few sequences of random bits known before a communication session to both communicating parties. Usually, there are two sequences—one to encrypt messages sent in one direction and the other to encrypt messages sent in the other direction. A sender takes a sequence of bits representing a message and combines them with bits of this one-time pad using logical XOR operation. After that, the sender destroys used bits of the one-time pad. A recipient uses the same bits of one-time pad to restore this message with the same logical XOR operation. After that, the recipient destroys used bits of the one-time pad. It is very fast encryption, but both parties have to secretly share a one-time pad, which is long.

In another approach, a sender uses a special algorithm, which meshes-up bits of the message. This algorithm uses a relatively short secret key as a parameter. A recipient has a reverse algorithm, which allows a restoration of the messages, when the key is known. An example is well known DES. This is a relatively slow encryption, but parties have to secretly share only a relatively small key.

It should not be possible to discern any pattern in one-time pad or in a key. Otherwise, there is a possibility of an attack on the encryption. The generation of such cryptographically secure random series of bits is computationally consuming or it requires the use of a special hardware.

A combination of both methods could be a method, where both parties need to share only a relatively short secret key and do not need to share secretly a one-time pad before the communication. A sender creates the one-time pad as needed, encrypts it using this secret key, encrypts its message using this one-time pad and passes to a receiver a combination of this encrypted one-time pad and an encrypted message. Unfortunately, this method is slow (it needs a generation of the one-time pad and the key-based encryption) and an encrypted message is at least two times longer than an original one; hence, it is not used.

Different variants of securing communication (encrypting) using one-time pad are described in following U.S. Pat. Nos.:

| | | |
|---|---|---|
| 6,104,811 | Aiello, et al. | Aug. 15, 2000 |
| 6,078,665 | Anderson, et al. | June 20, 2000 |
| 6,021,203 | Douceur, et al. | Feb. 1, 2000 |
| 5,751,808 | Anshel, et al. | May 12, 1998 |
| 5,717,760 | Satterfield | Feb. 10, 1998 |
| 5,703,948 | Yanovsky | Dec. 30, 1997 |
| 5,539,827 | Liu | July 23, 1996 |
| 5,515,307 | Aiello, et al. | May 7, 1996 |
| 5,483,598 | Kaufman, et al. | Jan. 9, 1996 |
| 6,128,386 | Satterfield | Oct. 3, 2000 |
| 6,088,456 | McCracken, et al. | July 11, 2000 |
| 6,076,097 | London, et al. | June 13, 2000 |
| 5,479,513 | Protopopescu, et al. | Dec. 26, 1995 |
| 5,440,640 | Anshel, et al. | Aug. 8, 1995 |
| 5,335,280 | Vobach | Aug. 2, 1994 |
| 5,297,207 | Degele | Mar. 22, 1994 |

### BRIEF SUMMARY OF THE INVENTION

The invention is a method of encrypted communication, where instead of one communication channel there are two channels; one channel is used to pass an encrypted one-time pad and the other channel is used to pass messages, encrypted with the help of this one-time pad; the one-time pad and messages are created and passed independently (with some coordination) and concurrently.

### DETAILED DESCRIPTION OF THE INVENTION

An encrypted communication should be viewed in a context of an application, where it is used.

In some applications especially in transaction based applications, a communication channel could be used for relatively short periods. Similar situation could be with a processor(s) load, for example because an application is waiting for a reply from a remote server, etc.

In other applications, there could be a clear asymmetry between communicating parties. For example one is a client, which runs in a device with low computational power, and the other is a server, which runs on a powerful computer with special hardware supporting cryptographic computations and the random number generation.

To utilize these communication and processing resources we separate a process of one-time pad creation and its exchange with other parties into a separate module—One-time Pad Module. One-time Pad Module uses its own communication channel(s) and works concurrently with the rest of an application. The rest of the application uses this one-time pad to encrypt and decrypt messages, which it exchanges with other parties.

One-time Pad Modules of communicating parties communicate between themselves independently.

Communication channel(s) of the One-time Pad Module and communication channel(s) of the rest of the application can be created through a usual multiplexing of an existing channel with the help of message headers.

At each communicating party, cooperating One-time Pad Modules create two parts of a one-time pad, one for sending (sending one-time pad) and another for receiving (receiving one-time pad). The application of a communicating party supplies to its One-time Pad Module an estimate of size of one-time pad, which it needs for an entire session. It corrects this estimate as the session progresses. Each time it sends a message, it requests from the One-time Pad Module a sending one-time pad of a length needed to encrypt a message. Each time it receives a message, it requests from the One-time Pad Module a receiving one-time pad of a length needed to decrypt a message.

In a general case, there could be a few communicating parties, which One-time Pad Modules cooperate in a creation of a one-time pad.

For example, two weak computing devices, which communicate between each other, can use the help of a powerful server to secure their communication. They communicate between themselves, and, in addition, they communicate with this server. This server creates and passes to them all needed parts of a one-time pad in an encrypted form. They decrypt these parts of one-time pad concurrently with their other operations and store them to secure their exchange of messages.

If one of communication parties is a weak computing device and the other is a server with sufficient resources, then the server can create all needed parts of one-time pad and pass them to the device in an encrypted form. The device decrypts them and stores to secure its exchange of messages.

In both cases, the device uses only key-based decryption and does not use key-based encryption. This opens a possibility to improve a speed of communication with asymmetric encryption algorithms, where decryption is fast at expense of slow encryption.

When communicating parties have comparable resources and load, they can share work of creation of a one-time pad. One party creates one part of it, the other party creates the other part of it and they exchange these parts in an encrypted form. For example, each party creates a one-time pad, which it uses to encrypt messages, which it sends.

In another setting, a party creates a part of one-time pad, which it uses to decrypt messages, which it receives. In this setting, One-time Pad Modules have to coordinate between themselves a size of this part of one-time pad, because it is based on requests of an application, running at other party.

It could be a case, when an application needs to wait for a One-time Pad Module to complete its work with cryptographic procedures or communication. It happens, when the application requests a one-time pad of some length for a message (to encrypt or to decrypt it) and the needed part of one-time pad of this length is not ready yet. The shorter is a delay, caused by these cases, the more efficient is an offered here approach to securing of communication.

Following is a description of an implementation of this method.

A distributed application consists of a server, which runs on a multiprocessor computer, and clients, which run on PCs. Clients securely communicate with this server.

A server computer has a cryptographic hardware, which speeds up cryptographic computations and provides a random bits generation.

One-time Pad Modules are implemented as software objects. They can be created, when they are needed, and they use their own threads of execution, independent from the rest of application.

One-time Pad Modules use Secure Socket Layer (SSL) protocol, which is common on the Internet.

When a client connects to the server, it creates two sockets and an instance of software object—a One-time Pad Module. It uses the first socket to exchange messages with the server, securing them with a one-time pad. The second socket is used by the One-time Pad Module.

When the server connects to a client, it creates two sockets and an instance of software object dedicated to this client—a One-time Pad Module. It uses the first socket to exchange messages with the client, securing them with a one-time pad. The second socket is used by the One-time Pad Module.

The client and the server pass to their respective One-time Pad Modules an estimate of the size of a one-time pad, which they need to send their messages.

The server's One-time Pad Module starts creating a part of one-time pad needed to sent its messages, in a separate execution thread, as soon it receives the estimate of its size.

In the beginning of the client-server communication, the One-time Pad Module of the client and the dedicated to this client One-time Pad Module of the server establish a secure session through an SSL Handshake protocol.

The client's One-time Pad Module passes to the server's One-time Pad Module the estimate of the size of the part of one-time pad, which it needs to send client's messages.

The server's One-time Pad Module starts creation of the part of one-time pad, which the client needs to send its messages, in a separate execution thread, as soon as it receives its size.

Both parts of one-time pad created by the server's One-time Pad Module are passed securely to the client using SSL Record Layer protocol. They are passed in pieces, as pieces are generated.

When the server finds, that it needs a longer part of one-time pad to send its messages to the client, it informs the dedicated to this client One-time Pad Module. The One-time Pad Module generates new pieces of this part of one-time pad and passes them to the client's One-time Pad Module.

When the client finds, that it needs a longer part of one-time pad to send its messages to the server, it informs its One-time Pad Module and it informs the dedicated to this client server's One-time Pad Module. The server's One-time Pad Module generates new pieces of this part of one-time pad and passes them to the client's One-time Pad Module.

When client-server communication ends, both One-time Pad Modules are destroyed.

I claim:

1. A method of securing communication, where
messages are passed between communicating parties encrypted with a one-time pad, for example by combining bits of a message and bits of the one-time pad using a logical XOR operation, through one channel or a group of channels,
the one-time pad is exchanged between communicating parties through another channel or a group of channels in an encrypted form with the use of private key encryption, for example DES.

2. The method of securing communication of the claim 1, where the one-time pad is generated and passed between communicating parties concurrently with the rest of an application, which uses this secure communication.

3. The method of securing communication of the claim 1, where the one-time pad is entirely generated by one communicating party and used by other communicating parties, and possibly by this one also.

4. The method of securing communication of the claim 1, where the one-time pad consists of two or more parts, each part is generated by a different communicating party and parts are exchanged between communicating parties in an encrypted form.

5. The method of securing communication of the claim 1, where a part of one-time pad is broken into a sequence of pieces and passed between communicating parties in pieces.

6. The method of securing communication of the claim 5, where the additional pieces of one-time pad are generated and passed between communicating parties as needed.
